(19) United States
(12) Patent Application Publication
(10) Pub. No.: US 2001/0017288 A1
(43) Pub. Date: Aug. 30, 2001

(54) Electromagnet and operating mechanism of switch therewith

(76) Inventors: Ayumu Morita, Hitachi (JP); Tooru Tanimizu, Hitachi (JP); Masato Yabu, Hitachi (JP)

Correspondence Address: McDermott, Will & Emery, 600 13th Street, N.W., Washington, DC, 20005-3096, US

(21) Appl. No.: 09/790,721

(22) Filed: Feb. 23, 2001

(30) Foreign Application Priority Data
Feb. 23, 2000 (JP) 2000-52097

(51) Int. Cl. H01H 3/00

(52) U.S. Cl. 218/154

(57) ABSTRACT

An electromagnet according to the present invention comprises a fixed core 1 formed by side legs 2b provided on both sides of a central leg 2a produced by laminating a plurality of steel plates, and a yoke 2c for connection between the central leg and the side legs, the central leg, the side legs, and the yoke being integral with each other; an exciting coil 4 wound around the central leg 2a; and a moving core 3X opposed to the central leg and the exciting coil which is moved along the side legs; wherein length of the side legs 2b is longer than that of the central leg; and the moving core 3X opposed to the central leg 2a has a projection 3a extending to the central leg side. Therefore, occurrence of eddy current is reduced and attractive force is increased.

### BACKGROUND OF THE INVENTION

The present invention relates to an electromagnet and an operating mechanism of a switch using the electromagnet.

Conventional switch operating mechanisms include electrically-driven spring operating mechanisms, hydraulic and pneumatic operating mechanisms. Generally, such operating mechanisms have a large number of parts and complex link mechanisms, and therefore involve relatively high manufacturing cost. As one of the means for simplifying link mechanisms, an operating mechanism utilizes an electromagnet. In a vacuum contactor disclosed in Japanese Patent Laid-Open No. Hei 5-234475, for example, an electromagnet is used for closing operation, and the contacts are opened by releasing a tripping spring whose energy is stored on closing the contactor. In an operating mechanism disclosed in Japanese Patent Laid-Open No. Hei 10-505940, a plunger that extends through two coils for closing and tripping operations is provided, and both closing and tripping operations are performed by an electromagnet.

Generally, a plunger type electromagnet is used as an electromagnet employed in an operating mechanism of a switch in order to ensure attractive force in a long stroke. However, in a conventional plunger type electromagnet, the plunger is formed by a magnetic rod, and therefore it presents a problem of effects of eddy current in the plunger. In an electromagnet used in an operating mechanism of a switch, generally a coil is energized by an external direct-current power supply. In this case, change of current with time, that is, operating time is determined by a time constant L/R defined by the inductance L of the coil and the resistance R of the coil and wiring.

However, when eddy current occurs in the plunger, penetration of a magnetic flux into the plunger takes time, thereby causing a delay in operating time. Therefore, in order to ensure a required operating time, there is no other way but to increase the magnetic flux (increase the number of turns of the coil or current) or increase the diameter of the plunger, thus resulting in a larger electromagnet.

Also, recently, there has been considered a system in which a capacitor is provided for a power supply of an electromagnet, and an electric charge stored in the capacitor is released for energization, as in an operating mechanism disclosed in Japanese Patent Laid-Open No. Hei 10-505940. In this case, current waveform represents a resonance oscillation having a period (½√LC) determined by the capacitance C of the capacitor and the inductance L of a coil, and therefore penetration of a magnetic flux into a plunger not only takes time but also is effective only to a thickness determined by skin effect.

### SUMMARY OF THE INVENTION

It is accordingly an object of the present invention to provide an electromagnet of smaller size and an operating mechanism of a switch of smaller size that uses the electromagnet.

According to one aspect of the present invention, there is provided an electromagnet comprising a fixed core formed by a central leg produced by laminating a plurality of steel plates, side legs provided on both sides of the central leg, and a yoke for connection between the central leg and the side legs, the central leg, the side legs, and the yoke being integral connecting with each other; an exciting coil wound around the central leg; and a moving core disposed between the side legs which is attracted to the central leg and moved along the side legs; wherein length of the side legs is longer than that of the central leg.

According to another aspect of the present invention, there is provided an operating mechanism of a switch for closing and opening an electrode on one side and an electrode on the other side, comprising a closing electromagnet for closing operation having a laminate portion of a fixed core and a moving core formed by laminating a plurality of steel plates and a width portion having a value greater than the thickness of the laminate portion and extending in a direction normal to the laminate portion, along which legs and the moving core are disposed; wherein a lever is disposed so as to be opposed to the central leg and the side legs of the fixed core of the closing electromagnet and the exciting coil; the moving core is disposed between the central leg, the side legs, and the exciting coil and the lever; and the laminate portion of the fixed core and the moving core is disposed in a direction normal to that of arrangement of the multiphase switch, and the width portion of the fixed core and the moving core is disposed on one side of the multiphase switch and in the same direction as that of arrangement of the multiphase switch.

### BRIEF DESCRIPTION OF THE DRAWINGS

FIG. 1 is a perspective view of an electromagnet according to an embodiment of the present invention;

FIG. 2 is a front view of the electromagnet of FIG. 1;

FIG. 3 is a front view of an electromagnet according to another embodiment of the present invention;

FIG. 4 is a graph showing a relation between L2/L1 distance ratio and attractive force F of the electromagnet of FIG. 3;

FIG. 5 is a sectional view of a vacuum circuit breaker according to an embodiment of the present invention in a closed state;

FIG. 6 is a sectional view of the vacuum circuit breaker of FIG. 5 in a tripped state;

FIG. 7 is a perspective configuration view of a closing electromagnet of the vacuum circuit breaker of FIGS. 5 and 6 and its vicinity;

FIG. 8 is a perspective view of a shaft and levers adopted in part of an operating mechanism of the vacuum circuit breaker of FIGS. 5 and 6 and their vicinities;

FIG. 9 is a sectional top plan view of a three-phase vacuum switch in FIGS. 5 and 6;

FIG. 10 is a power supply circuit diagram showing a power supply circuit of an exciting coil of a closing electromagnet used in the operating mechanism in FIGS. 5 and 6;

FIG. 11 is a power supply circuit diagram showing a power supply circuit of an exciting coil of a closing electromagnet according to another embodiment of the present invention; and

FIG. 12 is a power supply circuit diagram showing a power supply circuit of an exciting coil of a closing electromagnet according to a further embodiment of the present invention.

### DETAILED DESCRIPTION OF THE PREFERRED EMBODIMENTS

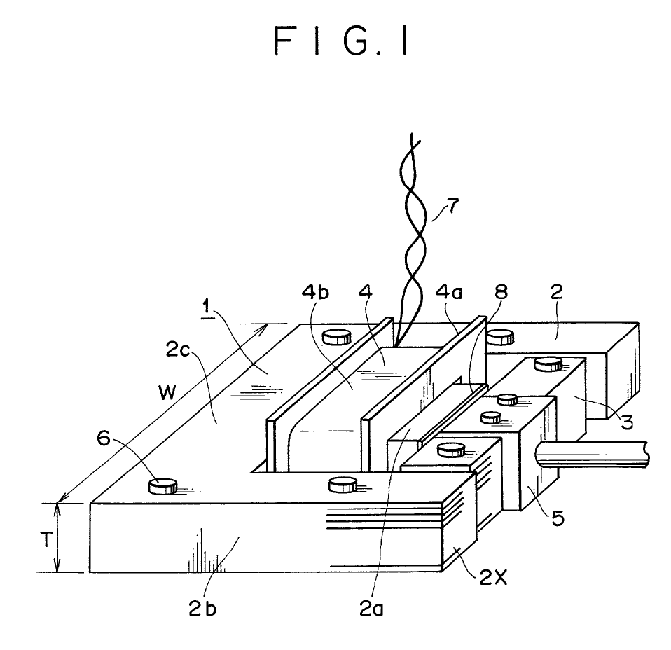

Preferred embodiments of the present invention will be described with reference to FIGS. 1 to 12.

### First Embodiment

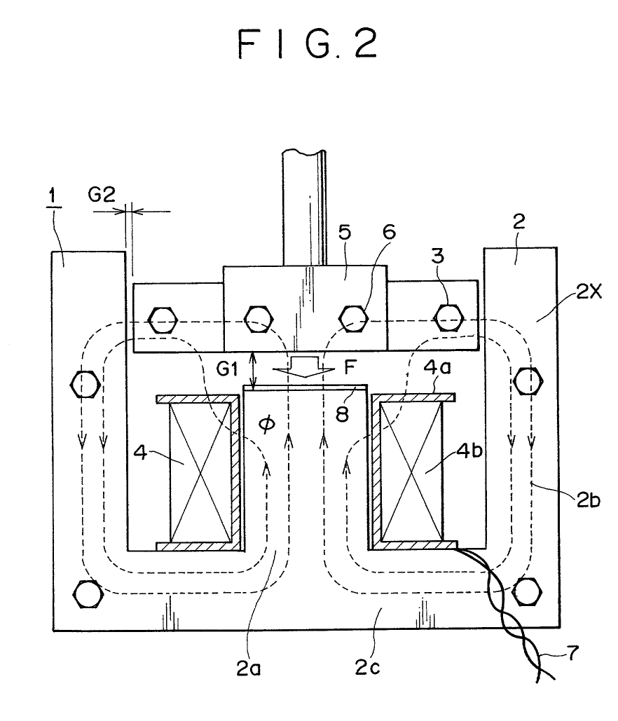

A first embodiment of the present invention will be described with reference to FIGS. 1 and 2. FIG. 1 is a perspective view of an electromagnet 1 according to the first embodiment of the present invention. A core of the electromagnet 1 is formed by a fixed core 2 and a moving core 3, and an exciting coil 4 is provided around a central leg 2a of the fixed core 2. The exciting coil 4 is formed by a bobbin 4a made of an insulator or a non-magnetic metal (aluminum, copper or the like) and a winding 4b, and a lead 7 connected to the exciting coil 4 is connected to an external power supply circuit. The fixed core 2 and the moving core 3 are formed by laminating silicon steel plates or thin steel plates 2X whose surfaces are provided with an insulating film formed by painting, coating or the like.

In a thin steel plate 2X that forms the fixed core 2, connection between the central leg 2a and a side leg 2b is provided by a yoke 2c, and the central leg 2a, the side leg 2b, and the yoke 2c are formed integrally with each other. The magnetic reluctance of the electromagnet 1 is determined by cross-sectional area of its core. Therefore, when the electromagnet 1 is designed in such a way that width W, which is set to be the width of the fixed core 2, is sufficiently greater than laminate thickness T, which is set to be the thickness of the laminate of thin steel plates 2X, the number of laminate plates is reduced, thereby resulting in lower cost of the electromagnet 1.

The side leg 2b is longer than the central leg 2a, so that the moving core 3 is opposed to the side leg 2b at all times even when it is moved. The thin steel plate 2X is fixed by a clamping fixture 6 such as a bolt or a pin. In the fixed core 2, the clamping fixture 6 is not provided to the central leg 2a, but is attached to the side leg 2b or the yoke 2c.

In order to avoid electrical connection between thin steel plates, it is preferable that the surface of the clamping fixture 6 be processed to provide insulation by painting, coating or the like. A thin non-magnetic plate 8 is provided on a surface of the fixed core 2 opposite to the moving core 3 in order to prevent a residual magnetic flux from impeding the tripping of the moving core 3. In addition, the moving core 3 is provided with a hinge 5 for connecting with an object to be driven.

Next, the operation of the electromagnet 1 according to the present invention will be described with reference to FIG. 2. FIG. 2 is a top plan view of the electromagnet of FIG. 1 with only the exciting coil 4 in section. When the exciting coil 4 is energized by an external power supply circuit, a magnetic flux Φ occurs within the core of the electromagnet 1, thus generating an attractive force F that acts between the central leg 2a and the moving core 3. Chain lines in FIG. 2 shows flux flow (magnetic lines of force). The attractive force F allows an object to be driven that is connected to the hinge 5 to be operated.

As shown in FIG. 2, in the electromagnet 1 of the first embodiment, a gap G1 between the central leg 2a and the moving core 3 changes. On the other hand, it is possible to maintain a constant gap G2 and thereby ensure a constant attractive force by making the side leg 2b longer than the central leg 2a and moving the moving core 3 on a long magnetic path while keeping the moving core 3 opposed to the side leg 2b at all times.

In the first embodiment, since the fixed core 2 and the moving core 3 are produced from a silicon steel plate or thin steel plates that are insulated from each other, eddy current occurring in the core is reduced. Therefore, there is no delay in generation of a magnetic flux in the core in response to a change in the current of the exciting coil 4, and also the magnetic flux passes through the entire cross section of the moving core 3. Thus, it is possible to produce a great attractive force and to thereby operate an object to be driven at high speed even with a small electromagnet.

In the electromagnet 1 according to the present invention, the side leg 2b and the yoke 2c are fixed by the clamping fixtures 6, while no clamping fixture 6 is provided to the central leg 2a. Therefore, the central leg 2a suffices to have a minimum cross-sectional area enough to provide a necessary magnetic flux. Consequently, the size of the exciting coil 4 can also be reduced.

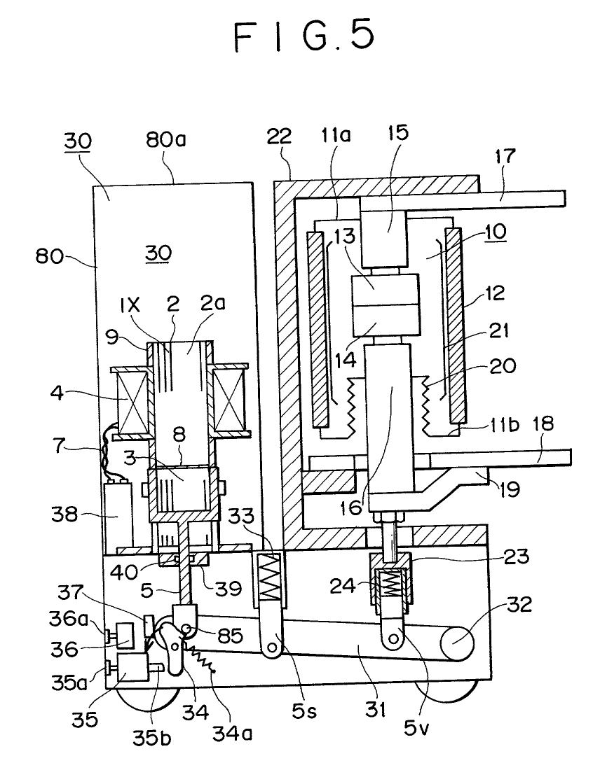

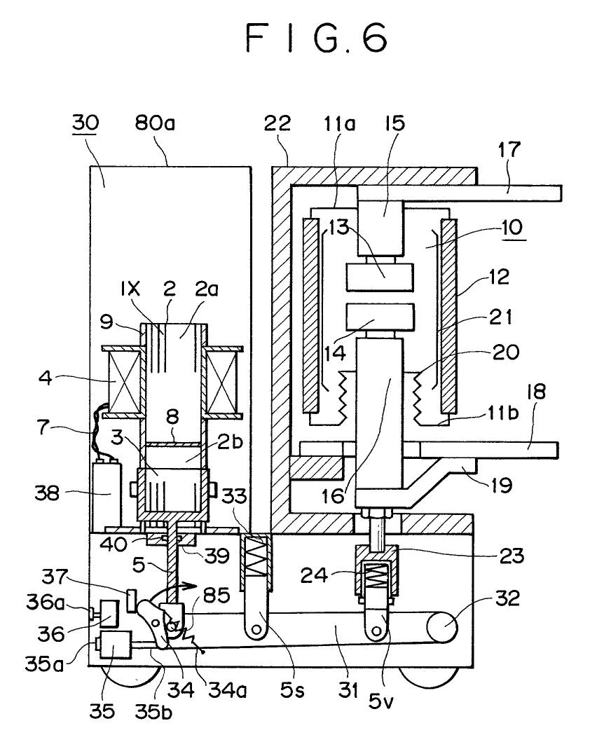

In the electromagnet 1 according to the present invention, the fixed core 2 is of a flat shape having the laminate portion T formed by laminating a plurality of steel plates and the width portion W greater than the laminate portion T along which width, or in a direction normal to the laminate portion T, the central leg 2a, the side leg 2b, and the moving core 3 are disposed. Therefore, when the electromagnet 1 is used in an operating mechanism of a switch, the operating mechanism of a switch can be miniaturized. This will be described later with reference to FIGS. 5 and 6.

### Second Embodiment

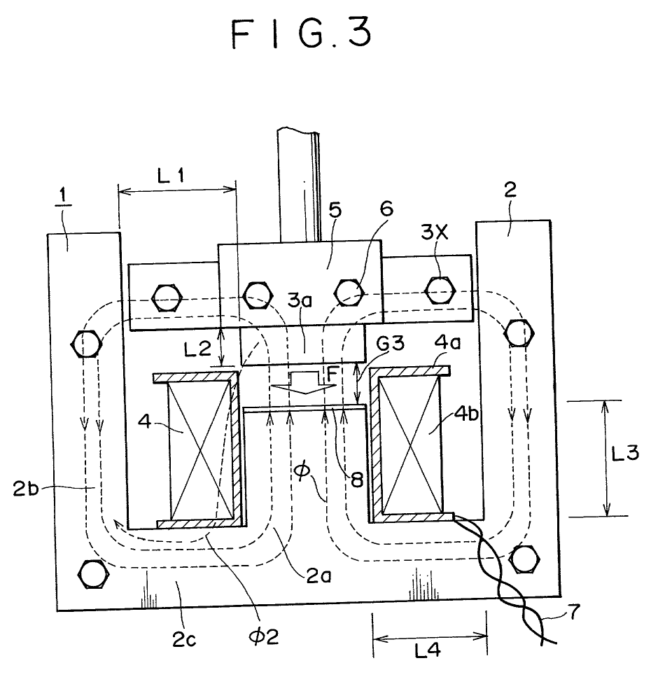

FIG. 3 shows an electromagnet 1 according to another embodiment of the present invention. The electromagnet 1 of the second embodiment is obtained by providing a projection 3a on the moving core 3X of the electromagnet of the first embodiment. The structure of an exciting coil 4, a manner of providing clamping fixtures 6 and the like are the same as those of the first embodiment. The projection 3a is disposed at the center of the moving core 3X so as to be opposed to a central leg 2a of a fixed core 2, and an attractive force F acting on a gap G3 between the moving core 3X and the fixed core 2 is utilized. The central leg 2a is made lower in height than the exciting coil 4 by the height of the projection 3a provided on the moving core 3X. As in the first embodiment, a thin non-magnetic plate 8 is provided on a surface of the central leg 2a opposite to the projection 3a in order to prevent a residual magnetic flux from impeding the tripping of the moving core 3X.

Effects of the second embodiment will be described. When the moving core 3X is moved, a gap G3 between the central leg 2a and the moving core 3X changes. In the meantime, the moving core 3X is moved on a long magnetic path while opposed to a side leg 2b at all times and maintaining a constant gap between the moving core 3X and the side leg 2b. Thus, it is possible to maintain a constant attractive force. Also in the second embodiment, all the cores including the moving core 3X are produced from silicon steel plates or thin steel plates that are insulated from each other, thereby making it possible to reduce effect of eddy current.

As is understood from magnetic lines of force represented by chain lines in FIGS. 2 and 3, when the I-shaped moving core 3 is used, magnetic flux leaks from side surfaces of the central leg 2a of the fixed core 2, whereas when the moving core 3X is used, such flux leakage is reduced. Since attractive force F is in proportion to the square of flux Φ of the gap, the attractive force F of the electromagnet using the moving core 3X is increased by an amount corresponding to a reduction of flux leakage by the projection 3a. The amount of leakage flux is determined by the structure of the core; specifically, when the length of the projection 3a of the moving core 3X is set to be L2 and a distance between the projection 3a and the side leg 2b is set to be L1, the amount of leakage flux is determined by a ratio between L1 and L2.

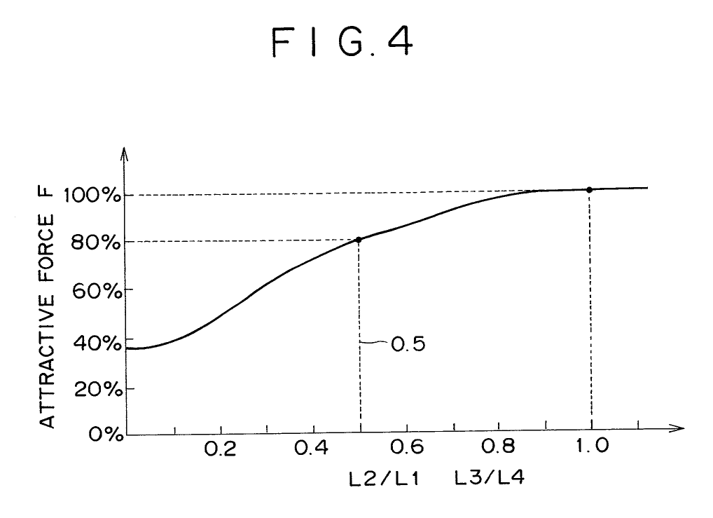

FIG. 4 shows a relation between L2/L1 ratio and attractive force F. L2/L1=0 corresponds to the case in which the I-shaped moving core 3 in FIG. 2 is used. When L1 is set to be a distance of 1 and the length L2 of the projection 3a is set to be 0.5 to 1, for example, the attractive force F of the electromagnet becomes 80% to 100%. Thus, it is possible to use the electromagnet in, for example, an operating mechanism of a switch without any practical problems.

When L2 is set to be a distance of less than 0.5, the attractive force F of the electromagnet is weakened. Therefore, the electromagnet needs to be made larger, which is not economical. If L2 is set to be more than 1, the attractive force F of the electromagnet is not increased. Instead, the weight of the moving core 3X is increased, and therefore operating speed at the throwing and breaking of a switch is reduced, thereby making it impossible to use the electromagnet as an operating mechanism. Accordingly, when L2/L1<0.5, leakage flux is increased and attractive force F is decreased. When 0.5≦L2/L1≦1, the electromagnet can be used in, for example, an operating mechanism of a switch without any practical problems. When L2/L1>1, attractive force F is not decreased, but the moving core 3X becomes larger, thus presenting problems in that operating speed is reduced and the electromagnet becomes larger.

Also, as is clear from FIG. 4, in order to efficiently operate the electromagnet 1, the core of the electromagnet 1 may be configured in such a manner as to satisfy an L2/L1 ratio of 0.5 to 1. In addition, the attractive force F of the electromagnet using the T-shaped moving core 3X can be increased because of the presence of the projection 3a, thereby making it possible to further miniaturize the electromagnet 1.

Furthermore, it is preferable to determine the length of the central leg 2a of the fixed core 2 in FIG. 3 from a viewpoint of flux leakage. When the length of the central leg 2a is set to be L3 and a distance between the central leg 2a and the side leg 2b is set to be L4, the characteristic of L3/L4 ratio is similar to that shown in FIG. 4. Therefore, it is preferable to set the L3/L4 ratio at 0.5 to 1. When the L3/L4 ratio is less than 0.5, a magnetic flux Φ2 flowing from the projection 3a of the moving core 3X to the yoke 2c of the fixed core 2 is created, thereby reducing the magnetic flux of the gap G3 and decreasing the attractive force F of the electromagnet. When the L3/L4 ratio is set to be more than 1, the attractive force F of the electromagnet is not increased, and therefore no effect can be obtained.

### Third Embodiment

Another embodiment of the present invention will next be described with reference to FIGS. 5 to 12. In a third embodiment, the electromagnet 1 of the first embodiment or the second embodiment is used as a closing electromagnet 1X of a switch.

FIG. 5 shows a fundamental configuration of an operating mechanism 30 of a switch to which a closing electromagnet 1X according to the present invention is applied. In the third embodiment, description will be made by taking a vacuum circuit breaker as an example; however, the breaker to be operated may be a gas circuit breaker, and the closing electromagnet 1X may be applied to switches in general, including disconnecting switches and grounding switches.

FIG. 5 shows a state in which the vacuum circuit breaker is closed. A vacuum switch 10 is closed with end plates 11a and 11b at the upper and lower ends of an insulating tube 12 made of glass or ceramic to seal the inside of the vacuum switch 10 and maintain a vacuum therein. Inside the vacuum switch 10, a fixed contact 13 and a moving contact 14 are disposed, and the fixed contact 13 and the moving contact 14 are connected to a fixed rod 15 and a moving rod 16, respectively. A bellows 20 is provided between the moving rod 16 and the end plate 11b on the moving rod side so that the moving rod 16 can be driven while maintaining a vacuum in the vacuum switch 10. A shield 21 provided around the periphery of the contacts is intended to prevent a decrease in creepage dielectric strength caused by metallic particles that are scattered when the contact is broken and then adhere to the surface of the insulating tube.

The fixed rod 15 and the moving rod 16 are electrically connected to a feeder 17 on the fixed rod side and a feeder 18 on the moving rod side via a flexible conductor 19, respectively, to form an electric circuit. Reference numeral 22 denotes an insulating support for holding the vacuum switch 10. Insulation between the operating mechanism 30 and the moving rod 16 is provided by an insulating rod 23. Incidentally, a wipe spring 24 is housed inside the insulating rod 23, so that contact force between the contacts is generated by the wipe spring 24 while a current is passed through the contacts.

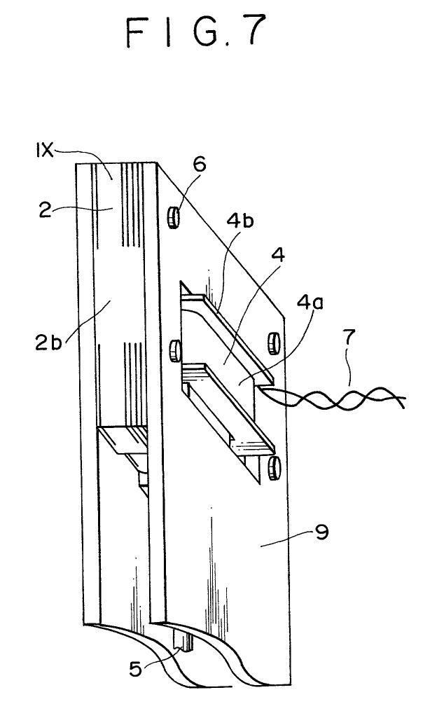

The configuration of the operating mechanism 30 will next be described. FIG. 5 shows the configuration of the circuit breaker in a closed state, and FIG. 6 shows the configuration of the circuit breaker in an opened state. FIG. 7 is a perspective view of the closing electromagnet of the operating mechanism 30 and its vicinity. The configuration of the closing electromagnet 1X is the same as that of the electromagnet described in the first embodiment. The electromagnet described in the second embodiment may also be used as the closing electromagnet 1X. Reference numeral 9 denotes a fixture for the closing electromagnet 1X, and the fixture 9 is fixed to the closing electromagnet 1X by clamping fixtures 6 provided on side legs 2b of a fixed core 2. The fixture 9 is fixed to a pedestal of the operating mechanism 30.

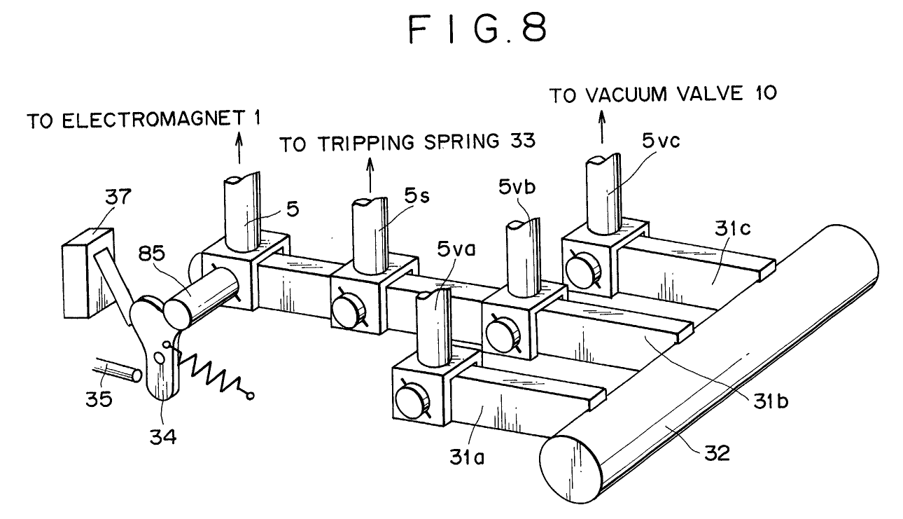

FIG. 8 is a perspective view of levers 31a, 31b, and 31c in which one end of each of the levers 31a, 31b, and 31c is connected to a shaft 32, and the other ends of the levers 31a, 31b, and 31c are connected to hinges 5va, 5vb, and 5vc, respectively. The levers 31a, 31b, and 31c for the three-phase vacuum switch 10 are fixed to the shaft 32. A hinge 5 connected to a moving core 3 of the closing electromagnet 1X is connected to the center lever 31b. The hinge 5 may be connected to the lever 31a or the lever 31c, depending on where to arrange the closing electromagnet 1X. However, considering the stress that will act on the shaft 32, it is preferable to connect the hinge 5 to the lever 31b. The levers 31a, 31b, and 31c are connected to the moving contact 14 of the vacuum switch 10 by means of the hinges 5va, 5vb, and 5vc and via the insulating rod 23.

As shown in FIG. 5, a closing push button 36a for a closing command and a tripping push button 35a are allowed to be operated from a front panel 80 of a control box 80a, and thereby the circuit breaker can be closed and tripped manually. When the circuit breaker is closed, a closing relay 36 is turned on by pressing the closing push button 36a, and then a current flows through an exciting coil 4. When the tripping push button 35a is pressed, a tripping electromagnet 35 is excited to move a plunger 35b, and then the plunger 35b and a latch 34 are disengaged from each other, thereby effecting the tripping of the breaker.

The operation of the operating mechanism 30 will next be described with reference to FIGS. 5, 6, and 10.

In a tripped state in FIG. 6, a limit switch 37 is turned on by the latch 34, and a capacitor 38 is charged with a current from a direct-current power supply 39. When the closing push button 36a is pressed, the closing relay 36 is activated and the plunger 35b is moved back to a position shown in FIG. 5. At this point, the moving core 3 is attracted to the fixed core 2, and therefore the hinge 5 of the moving core 3 is driven in an upward direction and the levers 31a, 31b, and 31c are moved on a fulcrum of the shaft 32 in an upward direction, that is, in a closing direction. At the same time, the hinges 5va, 5vb, and 5vc and the moving rod 16 are moved in an upward direction, and thereby the moving contact 14 and the fixed contact 13 are closed. Thus, the vacuum switch 10 is brought into a closed state. Reference numeral 39 denotes a bearing of the hinge 5. The bearing is provided to avoid misalignment of the surfaces of the fixed core 2 and the moving core 3 opposed to each other. In addition to the bearing 39, an O-ring 40 for movement may be used, as shown in FIGS. 5 and 6. After the moving contact 14 is brought into contact with the fixed contact 13, the closing relay 36 is turned off by the closing push button 36a, and discharging current from the capacitor 38 is discontinued.

Also, the lever 31b is connected with a hinge 5s for connection with a tripping spring 33. The tripping spring 33 is compressed with the closing operation, thereby storing compression energy. Simultaneously with completion of the closing operation, the latch 34 is engaged with a pin 85, whereby a closed state in FIG. 5 is retained.

When the circuit breaker is tripped, the tripping push button 35a is pressed, or the tripping electromagnet 35 is excited to move the plunger 35b from a position in FIG. 5 to a position in FIG. 6, and thereby the latch 34 and the pin 85 are disengaged from each other. At this point, the stored compression energy of the tripping spring 33 is released, and therefore the hinge 5 of the moving core 3 is driven in a downward direction and the levers 31a, 31b, and 31c are moved on a fulcrum of the shaft 32 in a downward direction, that is, in a tripping direction. At the same time, the hinges 5va, 5vb, and 5vc and the moving rod 16 are moved in a downward direction, and thereby the moving contact 14 is disengaged and tripped from the fixed contact 13. Thus, the vacuum switch 10 is brought into a tripped state. After the tripping operation is performed, the tripped state is maintained by the spring force of the tripping spring 33. The limit switch 37 is turned on by the latch 34, and the capacitor 38 is charged with a current from the direct-current power supply 39.

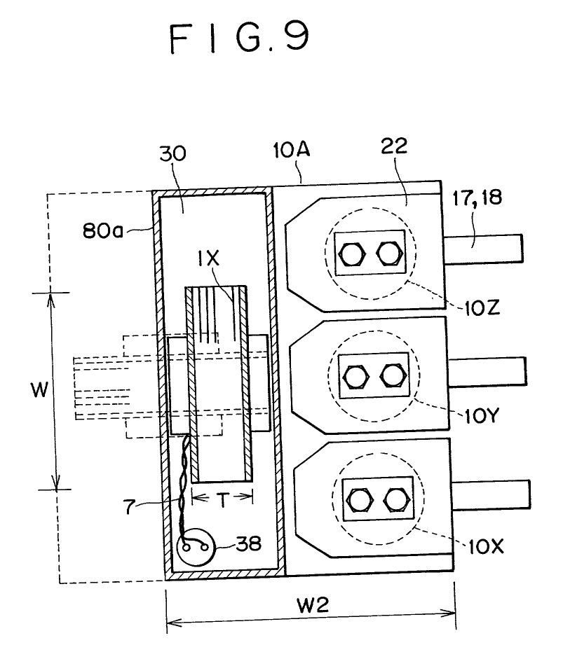

FIG. 9 is a top plan view of vacuum switchs 10X, 10Y, and 10Z of the three-phase vacuum switch 10. As described in the first embodiment, since the width W of the fixed core 2 and the moving core 3 is made sufficiently greater than their thickness T, the closing electromagnet 1X has a flat structure. The flat closing electromagnet 1X and the three-phase vacuum switch 10 are arranged in such a manner that the direction of width of the closing electromagnet 1X is in parallel with the direction of arrangement of the vacuum switch 10.

Specifically, as described with reference to FIG. 1, the closing electromagnet 1X is formed in such a way that the width W of the fixed core 2 and the moving core 3 is greater than the laminate thickness T of the laminate of thin steel plates 2X. The central leg 2a and the side legs 2b of the fixed core 2 and the exciting coil 4 of the closing electromagnet are disposed so as to be opposed to the lever 5. The moving core 3 is disposed between the lever 5 and the closing electromagnet including the central leg 2a, the exciting coil 4, and the side legs 2b, and the lever 31b is connected with the hinge 5 provided for the moving core 3. The laminate portion T of the fixed core 2 and the moving core 3 is disposed in a direction normal to the direction of arrangement of the vacuum switchs 10X, 10Y, and 10Z of the three-phase vacuum switch 10, and the width portion W of the fixed core 2 and the moving core 3 is disposed on an opposite side from where the feeder 17 on the fixed rod side and the feeder 18 on the moving rod side of the vacuum switchs 10X, 10Y, and 10Z of the three-phase vacuum switch 10 are projected and in the same direction as that of arrangement of the vacuum switchs 10X, 10Y, and 10Z of the three-phase vacuum switch 10.

Consequently, as compared with a case in which the laminate portion T and the width portion W of the fixed core 2 and the moving core 3 of the closing electromagnet 1X are arranged in a manner as indicated by chain lines in FIG. 9, depth dimension W2 of a vacuum circuit breaker 10A can be reduced, because according to the present invention, the width W of the fixed core 2 and the moving core 3 is disposed in the same direction as that of arrangement of the vacuum switchs 10X, 10Y, and 10Z of the three-phase vacuum switch 10. Thus, when a vacuum circuit breaker 10A according to the present invention is used in a switchboard, it is possible to reduce a dimension in a direction in which the vacuum circuit breaker is put in or out of the switchboard, that is, depth dimension of the switchboard.

Also, the operating mechanism 30 using the closing electromagnet 1X is disposed on the center lever 31b, and therefore, as contrasted to a case where the operating mechanism is disposed on either the left lever 31a or the right lever 31c, the closing electromagnet 1X will not extend beyond the left-phase vacuum switch 10X or the right-phase vacuum switch 10Z. Therefore, the depth dimension of the vacuum circuit breaker can be reduced without increasing the width W of the vacuum switchs 10X, 10Y, and 10Z of the three-phase vacuum switch 10.

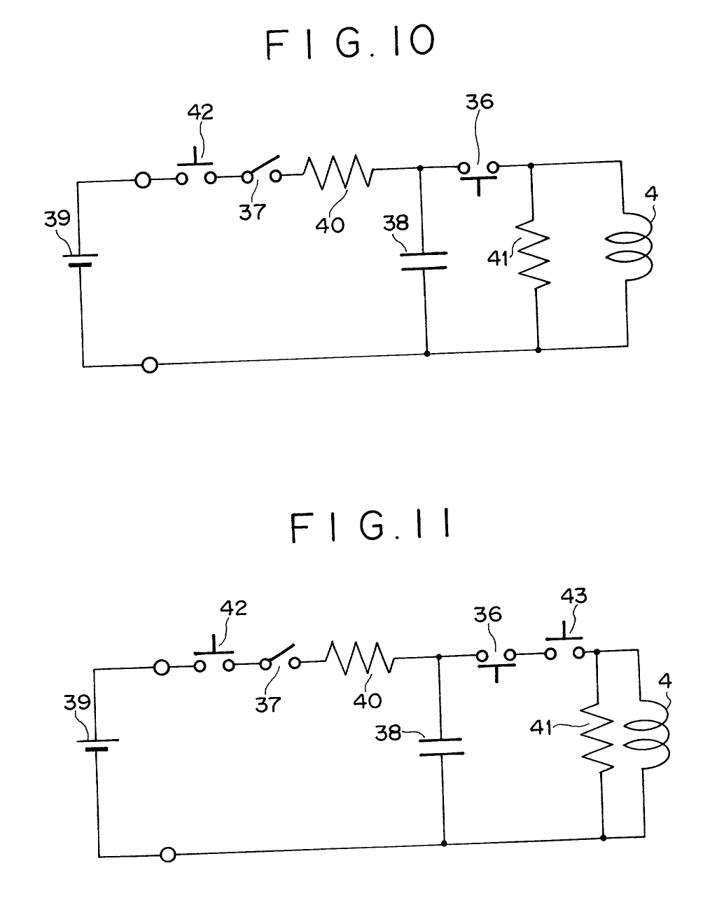

FIGS. 10, 11, and 12 show power supply circuits of the exciting coil 4. In FIG. 10, an external direct-current power supply 39 (power may also be provided by rectifying an alternating current) is connected to a capacitor 38 via a limit switch 37 and a charge resistance 40. The capacitor 38 is housed in an operating mechanism 30, as shown in FIGS. 5 and 6. The limit switch 37 is allowed to be activated by a latch 34, as shown in FIGS. 5 and 6. When tripping operation in FIG. 6 is completed, the latch 34 pushes the limit switch 37 on to begin charging. The value of the charge resistance 40 is determined according to a required charging time. Incidentally, b-contact of an auxiliary switch may be used instead of the limit switch 37.

A relay connected in series with the limit switch 37 is a timer relay 42, which is turned on in synch with the limit switch 37, and turned off when the preset charging time has passed. Thus, even when power supply from the power supply side is stopped, a charge stored in the capacitor 38 is not released, thereby allowing the vacuum circuit breaker to perform closing operation. The closing operation is achieved by providing a closing command to a closing relay 36 and thereby passing a current through an exciting coil 4. A resistance 41 is a protective resistance provided to prevent an electric breakdown of the exciting coil caused by an electromotive force Ldi/dt occurring when the closing relay 36 is cut off. In the closing operation, a mechanical state is maintained by the latch 34, and therefore the capacitor 38 may be discharged until the stored energy runs out.

A timer relay 43 in FIG. 11 interrupts the current flowing through the exciting coil 4 when the closing operation has been completed. In this case, residual energy remains stored in the capacitor 38, and therefore a charging time for which a charging current flows from the direct-current power supply 39 to the capacitor 38 after tripping operation is shortened, thereby resulting in better charging efficiency.

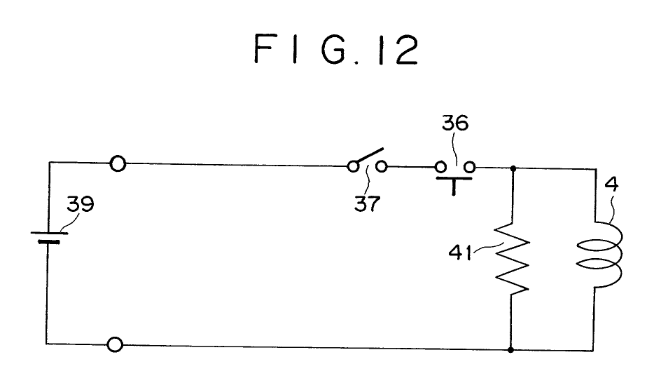

In a power supply circuit in FIG. 12, an exciting coil 4 is directly excited by a direct-current power supply 39. When a closing relay 36 is turned on in a tripped state (with a limit switch 37 on), the exciting coil 4 is energized, whereby closing operation is performed. When the closing operation is completed, the limit switch 37 is turned off, whereby the current is interrupted.

As described above, according to the present invention, it is possible to miniaturize an electromagnet and an operating mechanism of a switch using the electromagnet.

What is claimed is:

1. An electromagnet comprising:
a fixed core formed by a central leg produced by laminating a plurality of steel plates, side legs provided on both sides of the central leg, and a yoke for connection between said central leg and said side legs, the central leg, the side legs, and the yoke being integral with each other;
an exciting coil wound around the central leg; and
a moving core disposed between said side legs which is attracted to the central leg and moved along the side legs;
wherein length of said side legs is longer than that of the central leg.

2. An electromagnet comprising:
a fixed core formed by a central leg produced by laminating a plurality of steel plates, side legs provided on both sides of the central leg, and a yoke for connection between said central leg and said side legs, the central leg, the side legs, and the yoke being integral with each other;
an exciting coil wound around the central leg; and
a moving core disposed between said side legs which is attracted to the central leg and moved along the side legs;
wherein length of said side legs is longer than that of the central leg; and
a section of said moving core opposed to said central leg has a projection extending to a central leg side.

3. An electromagnet comprising:
a fixed core formed by a central leg produced by laminating a plurality of steel plates, side legs provided on both sides of the central leg, and a yoke for connection between said central leg and said side legs, the central leg, the side legs, and the yoke being integral with each other;
an exciting coil wound around the central leg; and
a moving core disposed between said side legs which is attracted to the central leg and moved along the side legs;
wherein length of said side legs is longer than that of the central leg;
a section of said moving core opposed to said central leg has a projection extending to a central leg side; and
when a distance between surfaces of said side leg and said projection opposed to each other is set to be L1 and a distance for which said projection extends to the central leg side is set to be L2, L2/L1 ratio is set at 0.5 to 1.

4. An electromagnet as claimed in claim 1,
wherein the electromagnet is a flat-shaped electromagnet having a laminate portion including said fixed core and said moving core formed by laminating a plurality of steel plates and a width portion having a value greater than the thickness of the laminate portion and extending in a direction normal to the laminate portion, along which the legs and the moving core are disposed.

5. An electromagnet as claimed in claim 4,
wherein steel plates forming said fixed core and said moving core are covered with insulating coatings.

6. An operating mechanism of a switch comprising:
a three-phase switch having switches disposed in three phases, each of the switches having at least a pair of electrodes disposed in a vessel, rods attached to said electrodes and extending to the outside of the vessel, and a hinge connected to a moving rod of the rods on one side;
a lever extending in a direction normal to the hinge attached to each of the switches of said three-phase switch; and
a shaft into which one end of the lever is inserted, the operating mechanism being disposed on the other end of the lever extending long to a side opposite to the shaft;
wherein the operating mechanism is moved to a closing side and a tripping side;
each lever on a fulcrum of the shaft operates the moving rod to make an electrode on one side in and out of contact with an electrode on the other side; and
the operating mechanism is moved to the closing side by a closing electromagnet;
said closing electromagnet comprising:
a fixed core formed by a central leg produced by laminating a plurality of steel plates, side legs provided on both sides of the central leg and longer than the central leg, and a yoke for connection between said central leg and said side legs, the central leg, the side legs, and the yoke being integral with each other;
an exciting coil wound around the central leg; and
a moving core disposed between said side legs which is attracted to the central leg and moved along the side legs;
wherein a laminate portion including said fixed core and said moving core is formed by laminating a plurality of steel plates, and a width portion having a value greater than the thickness of the laminate portion and extending in a direction normal to the laminate portion, along which the legs and the moving core are disposed;
the lever is disposed so as to be opposed to the central leg and the side legs of the fixed core of the closing electromagnet and the exciting coil;
the moving core is disposed between the central leg, the side legs, and the exciting coil and the lever;
a hinge provided for said moving core is connected to the lever; and
the laminate portion of the fixed core and the moving core is disposed in a direction normal to that of arrangement of the multiphase switch, and the width portion of the fixed core and the moving core is disposed on one side of the multiphase switch and in the same direction as that of arrangement of the multiphase switch.

7. An operating mechanism of a switch as claimed in claim 6,
wherein steel plates forming said fixed core and said moving core are covered with insulating coatings.
